(19) United States
(12) Patent Application Publication
(10) Pub. No.: US 2007/0038635 A1
(43) Pub. Date: Feb. 15, 2007

(54) Autosequencer

(76) Inventors: Bruce Aaron Tankleff, Woodlands, TX (US); Richard Oneil Matlock, Spring, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/201,785

(22) Filed: Aug. 11, 2005

(51) Int. Cl. G06F 17/30

(52) U.S. Cl. 707/10

(57) ABSTRACT

In an embodiment of a method of distributing an application program, the application program is installed on a first computer. Configuration information relating to the installation is recorded in machine-readable form. The configuration information is selected to enable installation of the application program on a second computer.

### BACKGROUND

Computer software is often supplied to the user not in the form of an immediately executable program, but in the form of an installation or setup program and supporting files. The installation or setup program then sets up the executable program on the user's computer. The setup process may be complex, requiring the creation of files and directories, alterations to system files and databases, and the entry of instructions, information, and choices by an operator supervising the installation.

Where the same setup needs to be created more than once, it has been proposed to create an image of the software in its executable form, and to download the image onto the user's computer. However, distribution of such image programs is not permitted by the licenses of some commercial software, and even slight differences between the hardware of different computer systems may render an image created on one system unusable on another system. It is therefore often necessary for each user to create the image separately, by running the full setup process.

The situation is especially acute when the executable application is not permanently installed on the physical computer on which it will run, but is streamed from an application server. The application server may then need additional information, such as a run-time sequence specifying the order in which components of the application are required when the application starts up and may most efficiently be streamed to the user computer.

It has been proposed to create a written script documenting a successful setup. An operator responsible for a subsequent setup then follows the script, rather than re-creating the setup. However, following a script still requires considerable time and attention from the operator, and is prone to errors.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a diagram of a computer system in accordance with embodiments of the present invention.

FIG. 2 is a flowchart of an embodiment of a method according to the invention.

FIG. 3 is a flowchart of an embodiment of a method according to the invention.

### DETAILED DESCRIPTION

Reference will now be made in detail to various embodiments of the present invention, examples of which are illustrated in the accompanying drawings.

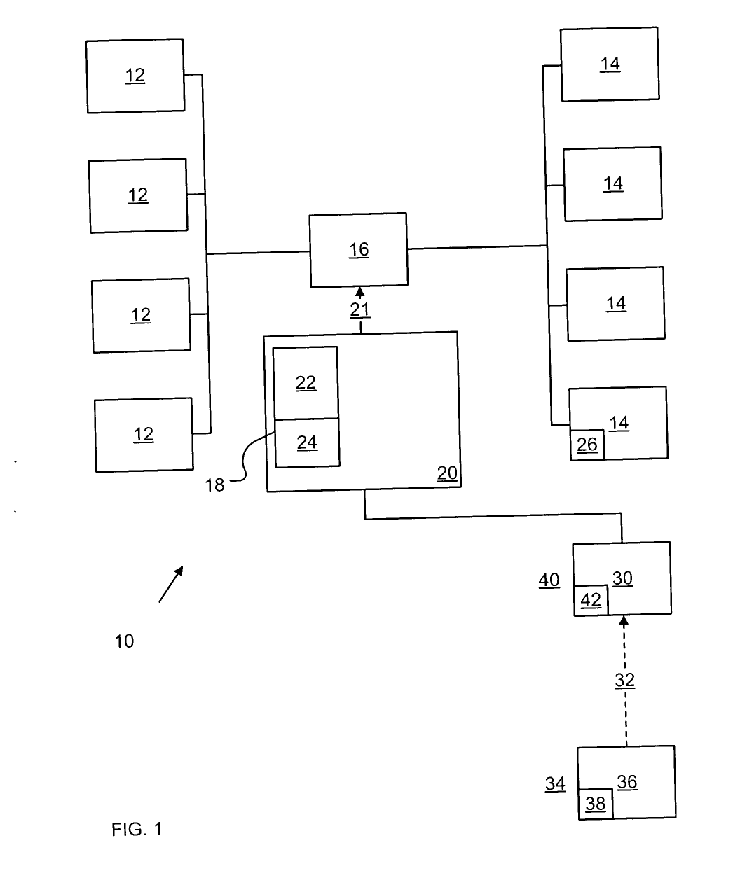

Referring to FIG. 1, a user computer system 10 comprises a number of user terminals 12 and a pool of processors, which may be in the form of blades 14, connected to the user terminals 12 by a controller 16. A blade 14 typically comprises a processor with RAM and ancillary components. When a user of one of the user terminals 12 requests to start a computing session, a blade 14 is assigned to the user terminal 12 by the controller 16. When the user logs off, the blade 14 is initialized to a clean state and returned to the pool of blades 14 for further use.

Application programs 18 are streamed to the blades 14 from an application server 20 according to the needs and entitlements of individual users during a session. The application server 20 stores a package 21 that comprises program files 22 and may also include one or more data files 24. The program files 22 correspond to the files that would be installed or created by installing the application program 18 locally on one of the blades 14. The program files 22 may include not only executable files but also other files, such as files of or for data, used by the application program 18 when it runs. The data files 24 are for use by the application server 20 and/or by a utility 26 that loads the streamed application program 18 on the blade 14. The data files 24 may include instructions on how to arrange the program files 22 within the file system of the blade 14. The data files 24 may include entries to be made to shared system files or databases of the blade 14, and instructions specifying where to make those entries. The application server 20 and/or the utility 26 can load the application program 18 on the blade 14 in executable form from the package 21 largely by merely copying the program files 22 in accordance with the instructions in the data files 24. For some application programs 18, loading from the package 21 may be considerably quicker and easier than installing the application program locally.

As is explained in more detail below, the package 21 of program files 22 and data files 24 is created by installing a copy of the application program 18 as supplied by an originating software house (not shown). That installation may be carried out on one of the blades 14, or may be carried out on a separate computer 30 with a similar configuration. The installation is assisted by using a template file 32 generated by a provider 34 using a provider computer 36. The provider 34 may be independent of the user of the computer system 10, for example, the provider 34 may be associated with the software house, or with a supplier of the computer system 10, or the provider 34 may be a supplier of template files 32. Alternatively, the provider may be, for example, associated with an operator of several computer systems 10.

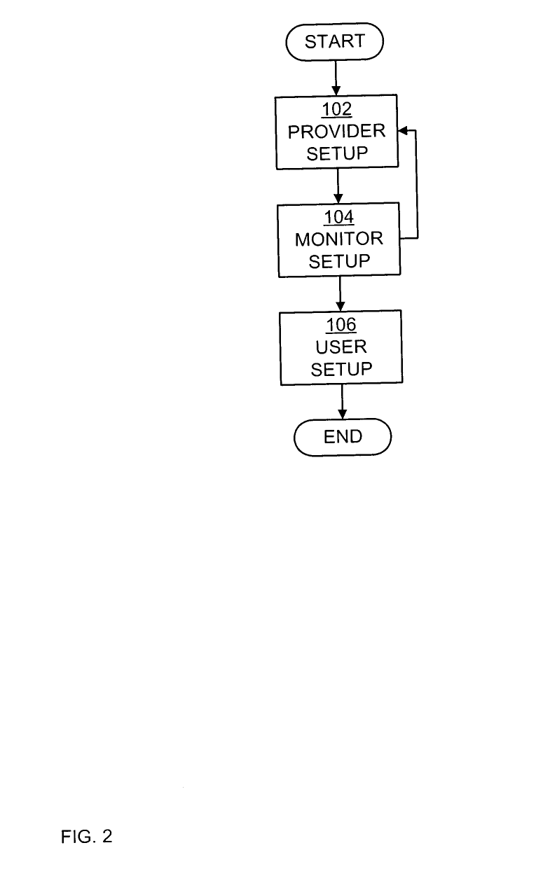

Referring now to FIG. 2, in one method of distributing an application program, in step 102 the provider 34 installs the application program 18 on the provider computer 36. Application programs 18 are typically supplied by the software house in an installation disk, download, or other form that contains, for example, compressed versions of program files 22. An installation or setup program decompresses compressed files, sets up file structures, and performs other functions as needed to install an executable program. The other functions typically including gathering configuration information by automatic inspection of the provider computer 36 on which the application program 18 is being installed and by requesting user input from the provider 34.

In step 104, while the application program 18 is being installed, the provider 34 runs a monitoring program 38 on the provider computer 36 that detects actions by and inputs to the setup program, and records those actions in machine-readable form in the form of the template file 32, which is then provided to an operator 40 of the computer 30.

In step 106, the operator 40 runs the setup program to install the application program 18 on the computer 30 using the template file 32 and a monitoring program 42 that applies the information in the template file 32.

Where the information in the template file 32 includes a record of actions by the setup program on the provider computer 36, the monitoring program 42 may record the actions by the setup program on the computer 30 and compare those actions with the template file 32. Any discrepancies may be referred to the operator 40, who may then determine whether the installation on the computer 30 is defective or whether there is some other explanation.

Where the information in the template file 32 created by the monitoring program 38 includes user input by the provider 34, the monitoring program 42 may read that user input from the template file 32 and feed that user input directly to the application program 18 being installed on the computer 30, saving the operator 40 from the time and trouble of inputting the same information.

The application program 18 may be run on the computer 30. Alternatively, as described in more detail below, the template file 32 may be modified to address any discrepancies between the installations on the computers 30 and 36 and the installation on the computer 30, together with the template file 32, may be used to generate a package 21 for the application server 20.

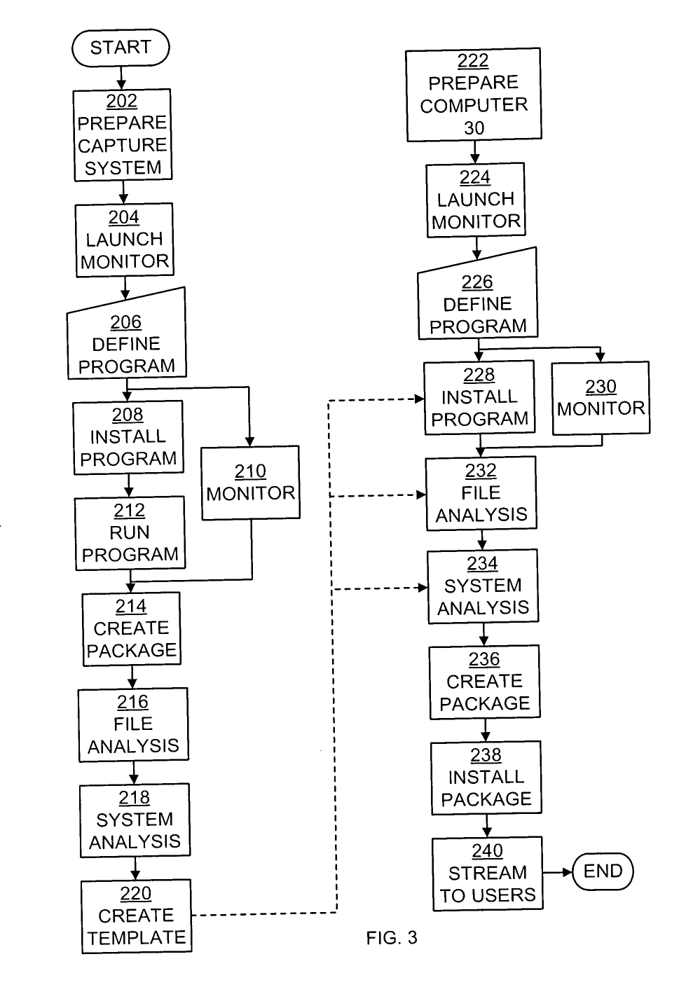

Referring now to FIG. 3, in a second method of distributing an application program, the provider computer 36 used for capturing and packaging an application program 18 may be a standard PC running the “lowest common denominator” operating system for all OS platforms that will be utilized by the application program 18. For example, where an application program 18 is to run on several versions of the same operating system, a package 21 that is generated on the earliest of those versions may generally also be used on some later versions. A package 21 that is generated on a later version is less likely to run on earlier versions of the operating system.

In step 202, the operating system is installed and configured on the provider computer 36, and the monitoring program 38 is installed on the provider computer 36. This initial configuration of the provider computer 36 may then be captured into an image from which this initial configuration can be re-created later if desired.

In step 204, the monitoring program 38 is launched from the operating system. In step 206, information specific to the application program 18 may be entered by the provider 34. The information may include the name of the application program 18, the operating systems that the eventual package 21 will support, and comments by the provider 34.

In step 208, the application program 18 installed on the provider computer 36, and in step 210 the installation is monitored by the monitoring program 38. Installation can include both the “standard” program installation carried out by the setup program and additional manual installation steps, for example, file updates. Steps 208 and 210 typically take place together over a significant period of time, and are shown symbolically as running in parallel. The monitoring program 38 builds a list of file additions and changes that occur as part of the installation. The monitoring program 38 also collects system configuration settings and/or updates.

In step 212, the application program 18 is executed, and the execution is monitored by the monitoring program 38, continuing step 210. Execution includes both normal program launch and termination and the launch and termination of application features or options that may be used by the ordinary user of the terminals 12. Step 212 can also include selecting and saving application configuration settings that are accessible from within the application itself and that are typically set by the user the first time the application program 18 is used. The monitoring program 38 may also capture updated system configuration settings during this time. The monitoring program 38 may also capture information on the order in which program files 22 are accessed as the application program 18 launches. This information may be used by the application server 20 to stream the program files 22 to the blades 14 in an efficient order, to minimize the apparent delay in streaming the application program 18 to the blades 14. Typically, an application program 18 accesses files in an at least partially predictable order, so that launching of the application program 18 on a blade 14 can start before all of the program files 22 are delivered to the blade 14.

In step 214, the monitoring program 38 may use the list of file system and configuration changes collected in step 210 during steps 208 and 212 to create a package 21. This package 21 may be manually copied onto the application server 20. The package 21 created in step 214 may also be used for testing.

In step 216, the list of file system changes that was collected in step 210 is parsed. Each entry may be reviewed for, and data may be collected on, the file object identity (name), type (for example, physical file or logical link), location (within the file system), time or stage (for example, during installation or execution) at which the file was modified, size (in bytes), and content (for example, in the form of a checksum). The list may also be reviewed for redundancy, for example, because a file was copied, created, or modified more than once during steps 208 and 212, and only the latest version is to be included in package 21. The list may also be reviewed for transience, where a file is created temporarily, then deleted, during steps 208 and 212, and may be omitted from the package 21.

In step 218, the list of system configuration settings and updates that was collected in step 210 may be parsed. Each entry may be reviewed for, and data may be collected on, the setting object identity (name), type (for example, physical file or setting, entry in a central configuration database, logical link or device), location within the operating system architecture, modification time or stage (installation or execution) at which the setting was modified, and content (value). The list may also be reviewed for redundancy, for example, where a setting is copied, created or modified more than once during steps 208 and 212 and only the last version is used in the package 21. The list may also be reviewed for transience, where settings and/or files are created temporarily, then deleted, during steps 208 and 212, and may be omitted from the package 21.

In step 220, the parsed and processed list of file object data from steps 216 and 218 is written to a template file. This file may be in a standard format such as Extended Markup Language (XML).

In step 222, the operating system is installed and configured on the computer 30, and the monitoring program 42 is installed on the computer 30. This initial configuration of the computer 30 may then be captured into an image, from which this initial configuration can be re-created later if desired. The computer 30 may be one of the blades 14. Alternatively, the computer may be very similar to the blades 14 apart from the monitoring program 42, so that computer-specific features of a local installation of application program 18 on the computer 30 will function correctly on blades 14.

In step 224, the monitoring program 42 is launched from the operating system. As in step 204, this provides a “fresh” system to be used for generating the new package 21 based on the existing template.

In step 226, information specific to the application program 18 may be entered. Because the template from step 220 is being used, the information entered in step 226 may be a subset of the information entered in step 206 sufficient to enable the monitoring software 42 to verify that the template relates to the correct file. The monitoring software 42 then extracts the remaining information from the template.

In step 228, similarly to step 208, the application program 18 may be installed locally on computer 30. The local installation on computer 30 provides a “file store” of program files 22 to be used in the creation of the new distribution package 21 from the template 32. The monitoring program 42 intercepts requests for user input during local installation on computer 30. Where the local installation on computer 30 is to replicate the configuration of the installation on provider computer 36, the monitoring program 42 feeds data from the template file 32 to the installation. Where the local installation on computer 30 is merely to provide a file store of program files 22 that it would be inappropriate to distribute from provider computer 36, the monitoring program 42 may select a “full” installation option that installs on computer 30 all the files that could have been included in the installation on provider computer 36 in 10 step 208.

Identifiers specific to the installation or implementation in system 10, such as unique product IDs, may also be captured by the monitoring program 42 monitoring the installation in step 230.

In steps 232 and 234, using the file store from the local installation along with the application template 32 from step 220, differences between the file system and configuration recorded in template 32 and that found on computer 30 are examined.

In step 232, the list of file system changes that was collected in step 230 may be parsed using the same methodology as in step 216. The data collected is compared to the list contained in the application template 32. In the case of a match, the file object is marked for inclusion in the new package 21. If a file 22 exists on the computer 30 but is not listed in the template file 32, the monitoring program may assume that the file is necessary for the local configuration on the computer 30. The file may be flagged for inclusion in the package 21, added to the template file 32, and an informational message is logged. Alternatively, where the local installation on the computer 30 is a full installation and the installation on the provider computer 36 is a smaller installation, the monitoring program may assume the file 22 is unnecessary and omit it from the new package 21.

If a file 22 exists in the template file but is missing on the computer 30, the monitoring program 42 may assume that the local installation on the computer 30 is defective. The monitoring program 42 may flag the discrepancy as a fatal error, log supporting data, and exit. In the case of content mismatches, for example, an invalid checksum, a warning is logged.

In step 234, the list of system configuration settings and updates that was collected in step 230 may be parsed using the same methodology as in step 218. The same rules as in step 232 may be used for matching these settings and for processing mismatches. However, the analysis program 42 may flag settings that have different values for later review by the operator 40. Such different settings may include settings, for example, product IDs, where the setting from step 230 is included in the template file 32 in preference to the setting from step 210. Alternatively, the analysis program 42 may have built-in logic to recognize specific settings such as Product IDs, record the new value without requiring review by the operator 40, and log an informational message.

Settings that result from customized configuration of the installation in the provider computer 36, where it is intended that the customization be adopted by the user 40 without being manually configured in the local installation on the computer 30, may be flagged as such in the template file 32 and may be adopted by the monitoring program 42 with or without an informational message. Settings that were created in step 212 and recorded by the monitoring program 38 in step 210 may also be adopted by the monitoring program 42 with or without an informational message.

In step 236, a new set of program files 22 may be created based on the comparison between the template file 32 and the installation on the computer 30. A new sequence package 21 may be built based on the features included in the local installation on the computer 30, with configuration changes and installation specific data being placed in the package 21.

In step 238, the package 21 may be loaded onto the application server 20, and in step 240 the package 21 may be streamed to the blades 14 and used by the users of the terminals 12.

Various modifications and variation can be made in the present invention without departing from the spirit or scope of the invention. Thus, it is intended that the present invention cover the modifications and variations of this invention provided they come within the scope of the appended claims and their equivalents.

For example, the application program 18 installed on the computer 30 is typically not the same exact copy of the application program 18 that was installed on provider computer 36 in step 208. The two copies may be different builds, or even different versions, provided they are sufficiently similar that the template file 32 generated from the copy on provider computer 36 is applicable to the copy on computer 30. For example, the file structures of the two copies of application program 18 may have the same program files 22, but some of those files may have different checksums. Step 232 may then complete successfully, but with an informational message that enables the user 40 to recognize that different builds were involved.

The computer system 10 shown in FIG. 1 comprises user terminals 12 and blades 14 assigned by controller 16. Other forms of computer system may be used, for example, a system of personal computers connected by a network to the application server 18.

What is claimed is:

1. A method of distributing an application program, comprising:
installing the application program on a first computer; and
recording in machine-readable form configuration information relating to the installation, the configuration information selected to enable automatic installation of the application program on a second computer.

2. A method according to claim 1, further comprising installing the application program on the second computer using a configuration program that applies the information in machine-readable form.

3. A method according to claim 2, further comprising generating from the second computer a package representing the application program as installed on the second computer, and installing the package on at least one third computer.

4. A method according to claim 2, wherein installing the application program on the second computer comprises the configuration program configuring the application program as the application program is installed on the second computer.

5. A method according to claim 1, further comprising:
installing the application program on the second computer;
recording second configuration information relating to the installation on the second computer in machine-readable form;
comparing the second configuration information with the first the configuration information;
preparing modified configuration information based on the results of the comparison;
generating from the second computer and the modified configuration information a package representing the application program as installed on a computer; and
installing the package on a third computer.

6. A method according to claim 5, wherein installing the application program on the second computer comprises installing files including files that were not installed on the first computer, comparing the second configuration information with the first the configuration information comprises identifying which of the files installed on the second computer were installed on the first computer, and generating the package comprises selecting from the files installed on the second computer files that were installed on the first computer.

7. A method according to claim 1, wherein the configuration information comprises at least one of information relating to changes in a file system and information relating to changes in a system configuration.

8. A method according to claim 1, wherein the configuration information comprises information entered by an operator while installing the application program on the first computer.

9. A computer readable medium comprising computer readable code comprising instructions for:
monitoring the installation of an application program on a first computer; and
recording configuration information relating to the installation in machine-readable form.

10. A computer readable medium according to claim 9, further comprising instructions for comparing the configuration information with configuration information previously recorded by monitoring the installation of the application program on another computer.

11. A computer readable medium according to claim 10, further comprising instructions for generating a package for installation of the application program on a third computer using the results of the comparison.

12. A computer readable medium according to claim 11, wherein the configuration includes information identifying files, and wherein the instructions for generating a package further comprise instructions for selecting files identified in the configuration information previously recorded from among files installed on the first computer and instructions for generating the package including the selected files.

13. A computer readable medium according to claim 10, further comprising instructions for controlling the installation of the application program on the first computer using the configuration information previously recorded, the configuration information being selected to enable installation of the application program on the first computer.

14. A computer readable medium comprising computer readable code comprising configuration information recorded by monitoring the installation of an application program on a computer, the configuration information selected to enable installation of the application program on a second computer.

15. A computer readable medium according to claim 14, wherein the configuration information comprises at least one of information relating to changes in a file system during the installation, information relating to changes in a system configuration during the installation, and information entered by an operator during the installation.

16. A system for distributing an application program, comprising:
a first computer for installation of the application program; and
a monitoring program installed on the first computer for recording configuration information relating to the installation in machine-readable form, the configuration information selected to enable installation of the application program on a second computer.

17. A system according to claim 16, wherein the monitoring program is arranged to record the configuration information comprising at least one of information relating to changes in a file system and information relating to changes in a system configuration.

18. A system according to claim 17, wherein the monitoring program is arranged to record the configuration information comprising information entered by an operator while installing the application program on the first computer.

19. A system for distributing an application program, comprising:
a first computer for installation of the application program; and
a monitoring program installed on the first computer arranged to read configuration information in machine-readable form relating to a prior installation of the application program on a second computer, the configuration information elected to enable an installation of the application program corresponding to he installation on the second computer.

20. A system according to claim 19, wherein the monitoring program is arranged to control the installation of the application program on the first computer to correspond at least in part to the configuration information in machine-readable form.

21. A system according to claim 19, wherein the monitoring program is arranged to generate from the first computer and the configuration information in machine-readable form a package representing the application program as installed on the second computer in a form such that the application program can be loaded in executable form on at least one third computer.

22. A system according to claim 19, wherein the monitoring program is arranged to cause a full installation of the application program on the first computer, to compare the configuration information in machine-readable form with the first computer, to determine which of the files installed on the first computer are specified in the configuration information in machine-readable form, and to generate the package comprising files selected from among the files installed on the first computer, wherein the selected files correspond to the files specified in the configuration information in machine-readable form.

23. A system according to claim 21, wherein the monitoring program is arranged to generate the package comprising configuration information specified in the configuration information in machine-readable form entered by an operator while installing the application program on another computer.

24. A system for distributing an application program, comprising:
means for installation of the application program on a computer; and
means for reading configuration information in machine-readable form relating to an installation of the application program on a second computer, the configuration information selected to enable an installation of the application program corresponding to the installation on the second computer; and
means for controlling the installation of the application program on the first computer to correspond at least in part to the configuration information in machine-readable form.

25. A system according to claim 24, further comprising means for installation of the application program on the second computer; and
means for recording the configuration information in machine-readable form relating to the installation on the second computer.
